(19) United States
(12) Patent Application Publication
(10) Pub. No.: US 2021/0157929 A1
(43) Pub. Date: May 27, 2021

(54) METHOD FOR THE ANALYSIS OF SOURCE TEXTS

(71) Applicant: Continental Teves AG & Co. OHG, Frankfurt am Main (DE)

(72) Inventors: Marc Sebastian Patric Stöttinger, Frankfurt am Main (DE); René Palige, Frankfurt am Main (DE)

(73) Assignee: Continental Teves AG & Co. OHG, Frankfurt am Main (DE)

(21) Appl. No.: 17/165,670

(22) Filed: Feb. 2, 2021

Related U.S. Application Data
(63) Continuation of application No. PCT/EP2019/070138, filed on Jul. 25, 2019.

(30) Foreign Application Priority Data
Aug. 3, 2018 (DE) 10 2018 213 053.1

(51) Int. Cl. G06F 21/57; G06F 21/56; G06F 21/54

(52) U.S. Cl. CPC G06F 21/577; G06F 21/54; G06F 21/565

(57) ABSTRACT

A method for the analysis of source texts comprises identifying source text vulnerabilities that are susceptible to implementation attacks, wherein the identification of the source text vulnerabilities takes place during active source text development, without the need to compile the program.

### CROSS-REFERENCE TO RELATED APPLICATIONS

This application claims the benefit of PCT Application PCT/EP2019/070139, filed Jul. 25, 2019, which claims priority to German Application DE 10 2018 213 038.8, filed Aug. 3, 2018. The disclosures of the above applications are incorporated herein by reference.

### TECHNICAL FIELD

The invention relates to a method for the analysis of source texts, in particular, identifying source text vulnerabilities that are susceptible to implementation attacks.

### BACKGROUND

In the development of source texts, for example making use of an integrated development environment, source text developers are regularly supported in the generation of the source text so that the source text development is accelerated and the susceptibility of the later software to error is reduced.

A developer support known in the prior art is that of syntax highlighting, in which the source text is subjected during active source text development to a syntax check, so that source text errors can be identified during active source text development. The attention of the source text developer is drawn to the identified passages of source text through visual highlighting thereof during active source text development. As a result of the syntax highlighting, errors that occur during the compilation phase are reduced, so that the software development is accelerated.

In addition to syntax highlighting, real-time checks of source text are known that examine the source text for insecure standard functions such as strcpy or printf during active source text development. The source text can here, for example, be compared with a kind of dictionary of previously defined insecure standard functions. This is a merely static check, through which source text vulnerabilities that are susceptible to implementation attacks cannot be identified.

Until now it has only been possible to identify source text vulnerabilities that are susceptible to implementation attacks during a program's runtime, i.e. after the completion of programming and implementation. A software emulation, or the analysis of a test system, is necessary for this purpose, for example. The program compilation or the binary file is thus necessary to identify corresponding source text vulnerabilities. If source text vulnerabilities of this type are identified, it is thus necessary to again involve the source text development, whereby time-consuming and therefore expensive development loops are needed to rectify the identified vulnerabilities.

Furthermore, the known methods for the analysis of binary files often do not lead to a sensitization of the source text developers to corresponding vulnerability patterns. The known methods thus also do not lead the source text developers to make any learning progress.

Therefore, accelerating and/or simplifying the development of source texts that are not susceptible to implementation attacks is desirable.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method of identification of the source text vulnerabilities during active source text development takes place without the necessity of a program compilation.

Identification of source text vulnerabilities that are susceptible to implementation attacks during active source text development, time-consuming and expensive development loops that necessitate an emulation of software or the analysis of a test system can be avoided. The identification of such source text vulnerabilities during active source text development further enables immediate feedback to the source text developer, whereby a sensitization of the source text developer to corresponding source text vulnerabilities may be achieved.

The source text analysis thus covers the dynamic implementation behavior of the source text, and not only insecure standard functions such as strcpy or printf. For example, the expression implementation attack therefore does not refer to attacks that take place exclusively on the software level.

The method may be carried out partially or completely in an integrated development environment. The generation of a binary file may not be necessary for the identification of such source text vulnerabilities. The overall result is a acceleration of the development process and a reduced susceptibility of the source text to implementation attacks.

In one embodiment, the identification of the source text vulnerabilities that are susceptible to implementation attacks comprises the identification of source text vulnerabilities that are susceptible to side-channel attacks and/or the identification of source text vulnerabilities that are susceptible to fault injection attacks. Side-channel attacks and fault injection attacks represent sub-types of implementation attacks. Side-channel attacks can also be referred to as SCAs. Side-channel attacks exploit the physical implementation of a cryptographic system in a device or in software.

A device is observed here during the execution of cryptographic algorithms, and a correlation between the observed information and a key being used is investigated. Side-channel attacks of this sort can, for example, relate to the analysis of the runtime of an algorithm, the energy consumption during calculation processes, or the electromagnetic radiation.

Fault injection attacks can also be referred to as FIAs. In fault injection, malfunctions (glitches), for example, can be introduced into the supply voltage of a device. Another type of fault injection relates to the insertion of malfunctions in the clock signal of a device. Fault injection attacks are also known in which the device under attack is exposed to radiation.

The method is further developed in that the identified source text vulnerabilities are visually highlighted, wherein the visual highlighting of the identified source text vulnerabilities takes place during active source text development, without the need to compile the program. The visual highlighting can, for example, take place by means of a color background, setting a changed text color and/or setting a changed font type or a changed font style. Alternatively or in addition, a pop-up window can be displayed when corresponding source text vulnerabilities are identified, advising the source text developer of the identified source text vulnerability. Through the visual highlighting, or pointing out, of the identified source text vulnerability, a learning effect may be achieved for the source text developer. A sensitization of the source text developer for source text vulnerabilities that are susceptible to implementation attacks occurs.

In a further form of embodiment, the identification of the source text vulnerabilities and/or the visual highlighting of the identified source text vulnerabilities takes place in real time during active source text development. In this way, corresponding source text vulnerabilities can be immediately modified or replaced on-the-fly during programming by the source text developer. The whole development process is accelerated in this way.

The method is further developed in that a stored explanation of the identified source text vulnerability is loaded automatically. Alternatively or in addition, an explanation of the identified source text vulnerability is generated automatically. Depending on the complexity of the identified source text vulnerability, it may be sufficient for the source text developer to be made aware of the source text vulnerability by means of a stored explanation, and/or to make supplementary information relating to the identified source text vulnerability available to the source text developer by means of a stored explanation. In other cases, the identified source text vulnerability can be used to generate a corresponding explanation, so that the generated explanation comprises elements specific to the source text that relate to the source text actually formulated by the source text developer. Alternatively or in addition, the method can comprise the automatic display of the loaded or generated explanation about the identified source text vulnerability.

In one form of the method, an alternative source text to the identified source text vulnerability is automatically generated and/or the generated source text alternative to the identified source text vulnerability is displayed automatically. The alternative source text may not comprise a source text vulnerability that is susceptible to implementation attacks. The alternative source text can, in particular, comprise a new source text structure.

In one method the identified source text vulnerability is automatically replaced by the generated alternative source text on the basis of a correction command entered by a source text developer. The time-consuming manual adaptation of the source text in order to eliminate the identified source text vulnerability is in this way avoided. The source text development is further accelerated in this way.

The method may also be used for the analysis of source texts that are used in vehicles, in particular in automobiles. The source texts for vehicle-internal control devices may be used. Further fields of application include the development of smartcard software, developments relating to the Internet of Things, Industry 4.0 and other developments for areas in which devices interact with one another and a high degree of security is necessary.

A device for data processing that comprises a processor that is configured in such a way that it carries out the method for the analysis of source texts according to the embodiments described herein.

A computer program product comprises commands which, during the execution of the program by a computer, cause this to carry out the method for the analysis of source texts according to the above-described embodiments.

Additionally, a computer-readable data carrier on which the described computer program product is stored may also be possible.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will be discussed and described in more detail below with reference to the appended drawing. In the drawing:

FIG. 1 shows parts of an integrated development environment that can be called up by a device for data processing according to the invention.

### DETAILED DESCRIPTION

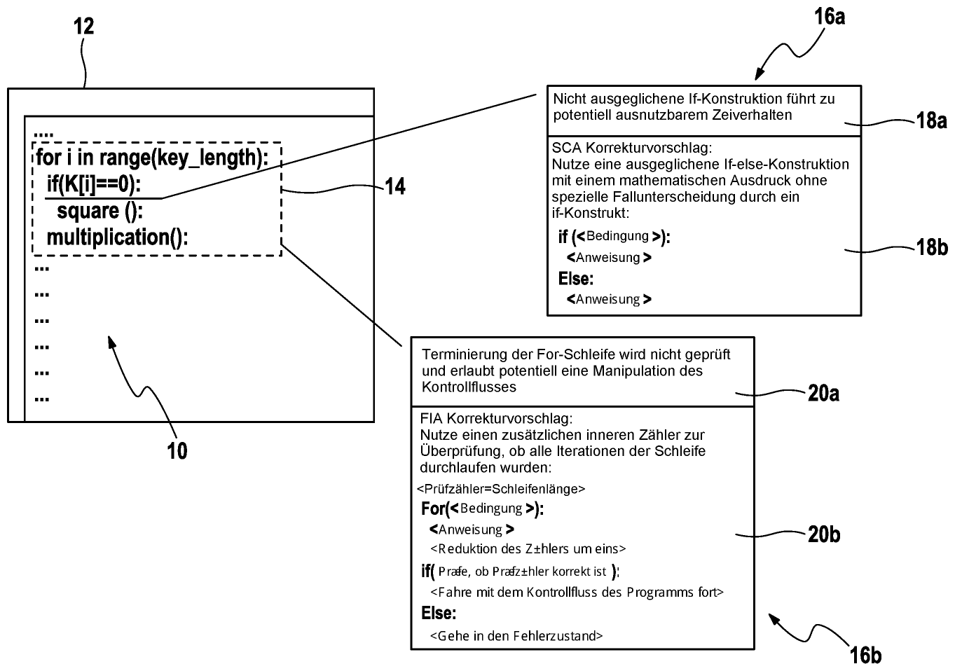

The integrated development environment illustrated in FIG. 1 shows schematically an exemplary embodiment of the method according to the invention for the analysis of source texts 10.

The method is carried out by a device for data processing, wherein the device comprises a processor that is configured such that it can carry out the method described below. The method is based on a computer program product that comprises commands which, when the program is carried out by a computer, cause it to correspondingly carry out the method.

Source text vulnerabilities 14 within a source text 10 entered by a source text developer are identified in the course of the method. The source text developer enters the source text 10 by way of an input device in the form of a keyboard into an editor 12. The identification of the source text vulnerabilities 14 takes place in real time during active source text development, without the need to compile the program.

Source text vulnerabilities 14 that are susceptible to implementation attacks such as side-channel attacks or fault injection attacks are identified in the context of the method. The source text analysis thus does not cover insecure standard functions such as strcpy or printf, but relates rather to the implementation behavior of the source text 10.

If source text vulnerabilities 14 that are susceptible to implementation attacks are identified, the identified source text vulnerabilities 14 are visually highlighted so that the source text developer is made aware of the source text vulnerabilities 14 during active development of the source text. The visual highlighting of the identified source text vulnerabilities 14 thus also takes place on-the-fly, i.e. during active development of the source text, without the need to compile the program.

In the present case, the source text 10 contains a for-instruction and an if-instruction. Both instructions are identified as susceptible to implementation attacks, and are visually highlighted.

The if-instruction, which is susceptible to side-channel attacks, has been identified as a source text vulnerability 14 in the context of the method. A window 16a, comprising the segments 18a, 18b, was opened for the if-instruction. A stored explanation relating to the identified source text vulnerability 14 is shown to the source text developer in segment 18a. Namely indicating that the if-instruction is not balanced and that a time behavior that can be misused can therefore occur. In segment 18b the source text developer is shown a suggested correction to eliminate the source text vulnerability 14, namely that the if-instruction should be combined with an else-instruction.

The for-instruction, which is susceptible to fault injection attacks, has been identified as a source text vulnerability 14 in the context of the method. A window 16b, comprising the segments 20a, 20b, was opened for the for-instruction. A stored explanation relating to the identified source text vulnerability 14 is shown to the source text developer in segment 20a. Namely indicating that an end has not been defined for the for-loop and that a control flow manipulation that can be misused can therefore occur. In segment 20b the source text developer is shown a suggested correction to eliminate the source text vulnerability 14, namely the insertion of a second counter value that checks whether all the iterations of the for-loop have been carried out. The insertion of an else-instruction to eliminate the source text vulnerability 14 is further proposed in segment 20b.

The alternative source texts displayed can thus have modified and/or expanded source text structures. Through the input of a corresponding correction command, the source text developer can initiate the replacement of the identified source text vulnerability 14 by the displayed alternative source text.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

1. A method for the analysis of source texts comprising:
identifying source text vulnerabilities in the program that are susceptible to implementation attacks, wherein the identifying occurs during active source text development without the need to compile the program.

2. The method as claimed in claim 1, further comprising:
identifying source text vulnerabilities that are susceptible to side-channel attacks; and
identifying source text vulnerabilities that are susceptible to fault injection attacks.

3. The method as claimed in claim 1, further comprising visually highlighting the identified source text vulnerabilities, wherein the visual highlighting takes place during active source text development without the need to compile the program.

4. The method as claimed in claim 1, wherein at least one of the identifying and the visual highlighting takes place in real time during active source text development.

5. The method as claimed in claim 1, further comprising at least one of:
automatic loading of a stored explanation regarding an identified source text vulnerability;
automatic generation of an explanation regarding an identified source text vulnerability; and
automatic display of the loaded or generated explanation of the identified source text vulnerability.

6. The method as claimed in claim 1, further comprising at least one of:
automatic generation of an alternative source text for an identified source text vulnerability; and
automatic display of the generated source text alternative to the identified source text vulnerability.

7. The method as claimed in claim 6, further comprising automatic replacement of the identified source text vulnerability by the generated alternative source text on the basis of a correction command entered by a source text developer.

8. A device for data processing comprising:
a processor that is configured with instructions for identifying source text vulnerabilities in the program that are susceptible to implementation attacks, wherein the identifying occurs during active source text development without the need to compile the program.

9. The device as claimed in claim 8, wherein the processor further comprises instructions for:
identifying source text vulnerabilities that are susceptible to side-channel attacks; and
identifying source text vulnerabilities that are susceptible to fault injection attacks.

10. The device as claimed in claim 8, wherein the processor further comprises instructions for visually highlighting the identified source text vulnerabilities, wherein the visual highlighting takes place during active source text development without the need to compile the program.

11. The device as claimed in claim 8, wherein at least one of the identifying and the visual highlighting takes place in real time during active source text development.

12. The device as claimed in claim 8, wherein the processor further comprises instructions for at least one of:
automatic loading of a stored explanation regarding an identified source text vulnerability;
automatic generation of an explanation regarding an identified source text vulnerability; and
automatic display of the loaded or generated explanation of the identified source text vulnerability.

13. The device as claimed in claim 8, wherein the processor further comprises instructions for at least one of:
automatic generation of an alternative source text for an identified source text vulnerability; and
automatic display of the generated source text alternative to the identified source text vulnerability.

14. The device as claimed in claim 13, wherein the processor further comprises instructions for automatic replacement of the identified source text vulnerability by the generated alternative source text on the basis of a correction command entered by a source text developer.

15. A computer program product comprising commands which, when the program is carried out by a computer, cause identifying source text vulnerabilities in the program that are susceptible to implementation attacks, wherein the identifying occurs during active source text development without the need to compile the program.

16. The computer program product of claim 15, wherein computer program product is stored on a computer-readable data carrier.
